(19) United States
(12) Patent Application Publication
(10) Pub. No.: US 2007/0107225 A1
(43) Pub. Date: May 17, 2007

(54) Toner supply roller and method of manufacturing the same

(75) Inventor: Tae-hyun Kim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/453,010

(22) Filed: Jun. 15, 2006

(30) Foreign Application Priority Data
Nov. 11, 2005 (KR) 2005-108201

(51) Int. Cl. F16C 13/00

(52) U.S. Cl. 29/895.2; 492/49

(57) ABSTRACT

A toner supply roller of a developing device includes a shaft and a resilient member enclosing the shaft. The resilient member includes a hybrid polyurethane foam containing an ionic conductive substance and an electron conductive substance. The toner supply roller is manufactured by impregnating a semi-conductive polyurethane foam having the ionic conductive substance with a resin solution containing the electron conductive substance, drying and cutting the impregnated polyurethane foam, and inserting and adhering a shaft into the dried, cut, and impregnated polyurethane foam.

### CROSS-REFERENCE TO RELATED APPLICATIONS

This application claims priority under 35 U.S.C. § 119(a) from Korean Patent Application No. 2005-108201, filed Nov. 11, 2005, the entire contents of which are incorporated herein by reference.

### BACKGROUND OF THE INVENTION

1. Field of the Invention

The present general inventive concept relates to a supply roller of a developing device useable in an image forming apparatus, and a method of manufacturing the same. More particularly, the present general inventive concept relates to a toner supply roller of a developing device, including an ionic conductive substance and an electroconductive substance, and a method of manufacturing the same.

2. Description of the Related Art

Electrostatic image forming apparatuses, such as a laser printer, a facsimile machine, and a copier, are provided with a conductive toner supply roller. FIG. 1 illustrates a structure of a laser printer 10 as an example of the electrostatic image forming apparatuses.

Referring to FIG. 1, a charger 11 of the laser printer 10 electrifies an image carrier 12. An electrostatic latent image is formed on a surface of the image carrier 12 by a light projected by a laser scanning unit 13. The electrostatic latent image is developed by a developing roller 14 into a toner image using toner T supplied by a toner supply roller 15. The toner image is transferred onto a paper P by a transfer roller 16 and then fixed by a fixing device 17. As one essential part of a developing device, the toner supply roller 15 supplies the toner to the developing roller 14 and recovers remaining toner not used for the development of the electrostatic latent image by the developing roller 14. The toner supply roller 15 maintains a constant coulomb per mass (Q/M) of the toner T in association with the developing roller 14 or a control blade 18.

FIG. 2 illustrates the toner supply roller 15 of the laser printer 10 of FIG. 1. As illustrated in FIG. 2, the toner supply roller 15 includes a shaft 15a and a resilient member 15b enclosing an outer circumference of the shaft 15a. The resilient member 15b of the toner supply roller 15 is usually implemented as a polyurethane foam or a silicon foam. The polyurethane foam has a lower hardness and costs less than the silicon foam. Since the polyurethane foam having relatively low hardness also has low toner stress and accordingly improves a lifespan of the toner supply roller 15, it is suitable for use in a high-speed image forming apparatus. The toner supply roller 15 including the resilient member 15b made of the polyurethane foam is capable of controlling a toner supply property and toner electrification according to a raw material of the urethane, a cell size, a hardness, a percentage of closed cells, and a density of the polyurethane foam.

Conventionally, an ionic conductive substance or an electroconductive substance is added to the foam, or the foam is impregnated with one of the the conductive substances, to electrify the polyurethane foam constituting the resilient member 15b of the toner supply roller 15. Here, an ammonium salt or a metal organic salt is used as the ionic conductive substance while carbon black is used as the electroconductive substance. However, since the foam may become sticky or collapse when the ionic conductive substance is excessively used, the ionic conductive substance should be added in a small amount. Accordingly, the conventional polyurethane foam does not have a resistance of a medium or a low degree.

In order for the toner supply roller 15 to have a low degree of resistance (about 1.0E+03 to about 9.0E+05, applied with −100V), the electroconductive substance (such as the conductive carbon black) is required. However, when the electroconductive substance (for example, the carbon black) is added to a polyol of the polyurethane foam, the polyurethane foam gets sticky due to a reaction of the electroconductive substance with an isocyanate of the polyurethane foam. Therefore, formation of the polyurethane foam becomes difficult, and it is hard to make a cell arrangement even. Moreover, in a case of manufacturing the conductive polyurethane foam by impregnating the polyurethane foam with an impregnant formed by mixing the electroconductive substance with a binder resin and then drying the resulting impregnated polyurethane foam, a resistance deviation per lot becomes undesirably high, thereby causing difficulty in mass-production of the polyurethane foam.

### SUMMARY OF THE INVENTION

The present general inventive concept provides a toner supply roller of a developing device, including a conductive hybrid polyurethane foam, which is economical because of a low cost and a low toner stress in spite of a longtime use since it has a low hardness.

The present general inventive concept also provides a method of manufacturing a toner supply roller of a developing device, which decreases a resistance deviation per lot during manufacture of the hybrid polyurethane foam, and which can be mass-produced.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a toner supply roller of a developing device, including a shaft, and a conductive resilient member enclosing at least a portion of an outer circumference of the shaft and including a hybrid polyurethane foam in which an electron conductive substance is dispersed in a semi-conductive foam containing an ionic conductive substance.

The hybrid polyurethane foam may have a resistance of approximately 1.0E+03 to approximately 9.0E+05 when −100V DC is applied to the shaft and the shaft is rotated at 30 rotations per minute (rpm).

The foregoing and/or other aspects and utilities of the present general inventive concept may also be achieved by providing a method of manufacturing a toner supply roller of a developing device, the method including preparing a polyurethane foam, fabricating a hybrid polyurethane foam by impregnating the polyurethane foam with a resin solution containing an electron conductive substance, preparing a conductive resilient member by drying and cutting the hybrid polyurethane foam, and inserting and attaching a shaft into the conductive resilient member.

The preparing of the polyurethane foam may include forming a premix polyol by adding a blowing agent, a surfactant, a catalyst, and a ionic conductive substance to a polyol, and adding polyisocyanate to the premix polyol to obtain a semi-conductive slab foam.

The method may further include post-processing the slab foam to obtain a filter foam. The filter foam can be post-processed to include a percentage of open cells of at least 80%.

The blowing agent may include water or a alkyl halide compound.

The catalyst can be selected from the group of organic metal compounds, amine compounds, and a mixture of those compounds. The organic metal compounds may include at least one metal selected from the group consisting of tin, lead, iron, and titanium.

The catalyst may include a tertiary amine or a tin catalyst.

The ionic conductive substance may be at least one compound selected from the group consisting of ammonium salt, perchlorate, chlorate, hydrochlorate, bromate, oxoacidic salt, fluoroboric acid salt, sulphate, ethylsulphate, carboxylate, sulphonate, at least one the above salts containing alkali metals, and at least one of the above salts containing alkaline earth metals.

The surfactant may be added in an amount in a range of approximately 0.1 to approximately 5 phr based on a weight of the polyurethane foam.

The resin solution containing the electron conductive substance may further include a binder resin and a solvent.

The electron conductive substance may include conductive carbon black.

The binder resin may include at least one substance selected from the group consisting of acrylic resin, polyacrylic acid ester resin, acrylic acid-styrene copolymer, polyvinyl alcohol, polyacrylamide, polyvinylchloride resin, urethane resin, vinyl acetate resin, butadiene resin, epoxy resin, alkyd resin, melamine resin, and chloroprene resin. The binder resin can be added in an amount within a range of approximately 5 to approximately 30 phr based on the amount of the resin solution.

The hybrid polyurethane foam may be dried by hot air drying.

The foregoing and/or other aspects and utilities of the present general inventive concept may also be achieved by providing a method of manufacturing a toner supply roller of a developing device useable in an image forming apparatus, the method including providing a conductive resilient member having a hybrid polyurethane foam including an electroconductive substance dispersed in a semi-conductive foam containing an ionic conductive substance, and enclosing an outer circumference of a shaft with the conductive resilient member.

The foregoing and/or other aspects and utilities of the present general inventive concept may also be achieved by providing a toner supply unit to supply toner to a developing unit of an image forming apparatus, including a hybrid polyurethane foam including at least one polyol, at least one polyisocyanate, at least one ionic conductive salt, and at least one electroconductive substance.

The foregoing and/or other aspects and utilities of the present general inventive concept may also be achieved by providing a toner supply unit to supply toner to a developing unit of an image forming apparatus, including a hybrid polyurethane foam including a semi-conductive polyurethane foam containing an ionic conductive salt and blown cells, and an electroconductive substance dispersed in the cells of the semi-conductive polyurethane foam.

The foregoing and/or other aspects and utilities of the present general inventive concept may also be achieved by providing a toner supply unit to supply toner to a developing unit of an image forming apparatus, including a hybrid polyurethane foam including a semi-conductive slab foam comprising at least one polyol, at least one polyisocyanate, and at least one ionic conductive salt, and at least one electroconductive substance impregnated in the semi-conductive slab foam.

The foregoing and/or other aspects and utilities of the present general inventive concept may also be achieved by providing a method of manufacturing a hybrid polyurethane foam useable in a toner supply roller to supply toner to a developing unit of an image forming apparatus, the method including mixing at least one polyol, at least one catalyst, and at least one ionic conductive substance to form a premix polyol, adding at least one polyisocyanate to the premix polyol to form a semi-conductive slab foam, and impregnating the semi-conductive slab foam with at least one electroconductive substance. The method may further include inserting a shaft through the impregnated slab foam and attaching the shaft and the impregnated slab foam to each other. The method may further include exploding closed cells of the semi-conductive slab foam before impregnating the semi-conductive slab foam.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a structure of a conventional laser printer; and

FIG. 2 is a perspective view illustrating a toner supply roller of the laser printer of FIG. 1.

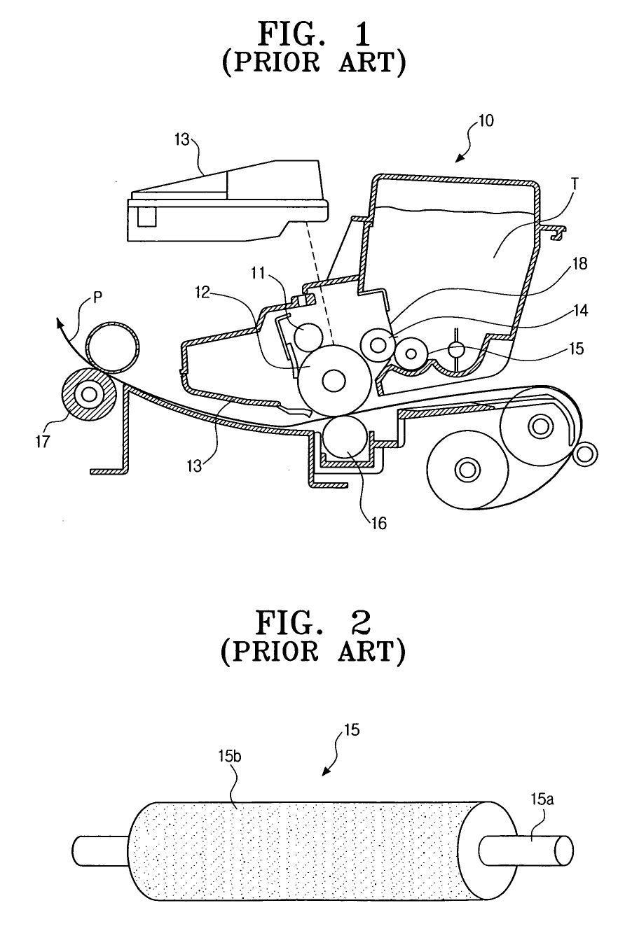

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Details defined in the following description, such as a detailed construction and elements of embodiments of hybrid polyurethane foams and hybrid toner supply rollers, are provided to assist in a comprehensive understanding of the general inventive concept. Thus, it is apparent that the present general inventive concept can be carried out without those defined details, and thus is not limited to those defined details. Also, well-known functions or constructions are not described in detail since they would obscure the general inventive concept in unnecessary detail.

According to an embodiment of the present general inventive concept, a conductive hybrid toner supply roller of a developing device of an image forming apparatus can include a shaft and a conductive resilient member enclosing an outer circumference of the shaft. A structure of a toner supply roller 15 of FIG. 2 may be used as an example of the conductive hybrid toner supply roller according to the present embodiment. The conductive resilient member is made of hybrid polyurethane foam containing an ionic conductive substance and an electroconductive substance. The hybrid polyurethane foam includes a polyurethane foam in which the electroconductive substance is dispersed in a semi-conductive foam containing the ionic conductive substance. The hybrid polyurethane foam can have a resistance of approximately 1.0E+03 to approximately 9.0E+05 when applying −100V of direct current (DC) voltage to the shaft and rotating the shaft at a speed of 30 rotations per minute (rpm).

In order to manufacture the toner supply roller of the developing device according to an embodiment of the present general inventive concept, a polyurethane foam is impregnated with a resin solution which includes the electroconductive substance to form the hybrid polyurethane foam.

The polyurethane foam may include a known or later-developed polyurethane foam. In this embodiment, a semi-conductive slab (slab foam) is obtained by adding a compound containing at least two active hydrogens and a compound containing at least two isocyanate groups. Specifically, a catalyst, a surfactant, a blowing agent, and an ionic conductive substance can be added to the slab form and agitatedly mixed to form a premix polyol. The premix polyol is a semi-conductive urethane foam having a low resistance of approximately 1.0E+07 to approximately 9.0E+10. A filter foam can be manufactured by blowing and hardening the premix polyol. The premix polyol can be blown into the filter foam so that a percentage of open cells of the filter foam is equal to or greater than 80%.

For the compound containing the at least two active hydrogens, a polyol used as material of the polyurethane foam may be used. For example, a polyether polyol, a polyester polyol, a polyetherester polyol having a hydroxyl group on its end, and a denatured polyol (such as acryl-denatured polyol and silicon-denatured polyol) can be used as the polyol material.

For the compound containing the at least two isocyanate groups, a polyisocyanate used as material of the general polyurethane foam may be used. For example, toluene diisocyanate (TDI), 4,4-diphenylmethane diisocyanate (MDI), a mixture thereof, or a denatured material of such polyisocyanates can be used as the polyisocyanate material.

According to the present general inventive concept, the ionic conductive substance may include at least one of the following compounds: ammonium salt, perchlorate, chlorate, hydrochlorate, bromate, oxoacidic salt, fluoroboric acid salt, sulphate, ethylsulphate, carboxylate, sulphonate, or one or more of the above salts containing alkali metals (such as Li, Na, and K) or alkaline earth metals (such as Ca and Mg). For example, the ionic conductive substance can include the ammonium salt, and the ammonium salt can include tetraethyl ammonium, tetrabutyl ammonium, lauryl trimethyl ammonium, decyltrimethyl ammonium, octadecyl trimethyl ammonium, stearyl tremethyl ammonium, benzyl trimethyl ammonium, and demethyl ethyl ammonium.

The catalyst should be selected in consideration of a blowing property, a reaction time, an improvement in a ventilation rate of foam, and a minimization of a density deviation. Also, an amount of the catalyst used should be controlled. Suitable catalysts include, but are not limited to, organic metal compounds (for example, organic metal compounds based on metals such as tin, lead, iron, and titanium), amine compounds, or mixture of those compounds. In embodiments, a tertiary amine and/or a tin catalyst can be used as the catalyst.

The blowing agent may include, for example, water or an alkyl halide compound (such as trichlorofluoromethane, which is a low-boiling point substance).

The surfactant improves a miscibility of the premix polyol by reducing a surface tension thereof, equalizes a size of generated hybrid polyurethane foams, and stabilizes the hybrid polyurethane foam by controlling a cell structure thereof. For example, a silicon surfactant can be used as the surfactant. In various embodiments, approximately 0.1 to approximately 5 phr of the surfactant is added based on an amount of the premix polyol. This is because effects of the surfactant are insufficient when an amount of the surfactant is less than approximately 0.1 phr, and a property of materials (such as a compression set property) including the surfactant may be deteriorated when the amount of the surfactant is greater than approximately 5 phr.

Thus, the hybrid polyurethane foam can be manufactured by impregnating the polyurethane foam prepared as described above with a resin solution including the electroconductive substance.

The resin solution can be prepared by adding the electroconductive substance and a binder resin in a solvent, such as water, alcohol, and ether.

The binder resin may include at least one of an acrylic resin, a polyacrylic acid ester resin, an acrylic acid-styrene copolymer, a polyvinyl alcohol, a polyacrylamide, a polyvinylchloride resin, a urethane resin, a vinyl acetate resin, a butadiene resin, an epoxy resin, an alkyd resin, a melamine resin, and a chloroprene resin. In embodiments, only one of these substances may be independently used as the binder resin, Alternatively, in other embodiments, a combination of two or more of these substances may be used as the binder resin. An amount of the binder resin can be within a range of approximately 5 to approximately 30 phr, exclusive of the endpoint values, based on an amount of the resin solution. When the amount of the binder resin is equal to or less than approximately 5 phr, adhesion of the electroconductive substance (e.g., carbon black) to cells of the polyurethane foam is insufficient. When the binder resin is equal to or greater than approximately 30 phr, a recovery force of the hybrid polyurethane foam is deteriorated.

The electroconductive substance may include conductive carbon blacks (such as super abrasion furnace (SAF) black, intermediate super abrasion furnace (ISAF) black, high abrasion furnace (HAF) black, fast extrusion furnace (FEF) black, general purposes furnace (GPF) black, semi-reinforcing furnace (SRF) black, fine thermal (FT) black, and medium thermal (MT), Ketjen black, and acetylene black), oxidation-treated carbon ink, thermal carbon, natural graphite, artificial graphite, conductive metallic oxides (such as tin oxide, titanium oxide, and zinc oxide), and metals (such as silver, nickel, copper, and germanium).

In this embodiment, the conductive carbon black is used as the electroconductive substance. When the conductive carbon black is used as the electroconductive substance, conductive carbon blacks having a small average particle diameter and a large surface area can be used. For example, Ketjen black EC, Ketjen black 300J, Ketjen black 600J, Balkan XC, Balkan CSX, the acetylene black (such as Denka black), and conductive furnace black may be used as the conductive carbon black having the small average particle diameter and the large surface area. An amount of the conductive carbon black can be, for example, approximately 3 to approximately 30 phr. When the amount of the conductive carbon black is less than approximately 3 phr, sufficient conductivity is not obtained. When the amount of the conductive carbon black is greater than approximately 30 phr, too many carbon black particles adhere to the urethane foam such that the carbon black particles are detached from the foam, or a mechanical property of the foam, such as resilience, may be deteriorated.

By impregnating the polyurethane foam described above with the thus-formed resin solution described above, the electroconductive substance can be dispersed into the cells in the polyurethane foam to form the hybrid polyurethane foam according to this embodiment of the present general inventive concept.

Next, the conductive resilient member according to this embodiment of the present general inventive concept is prepared by drying and cutting the hybrid polyurethane foam formed as described above. Here, the hybrid polyurethane foam can be dried by, for example, hot air drying.

The shaft is inserted into and adheres to in the conductive resilient member. Then, an outer surface of the conductive resilient member is polished. Consequently, the conductive hybrid toner supply roller is manufactured.

The hybrid toner supply roller has a low resistance of approximately 1.0E+07 to approximately 9.0E+10, which is not realized by a conventional toner supply roller with an ionic conductive substance. Moreover, since the hybrid toner supply roller contains the electroconductive substance through impregnation, the hybrid polyurethane foam is not collapsed, thereby reducing the resistance deviation of the hybrid polyurethane foam.

Hereinafter, Examples of hybrid toner supply rollers according to embodiments of the present general inventive concept and a Comparative Example will be described in detail.

### EXAMPLE 1

In Example 1, a hybrid polyurethane foam was manufactured as follows. A catalyst, a silicon surfactant, a blowing agent, and an ionic conductive substance were added to a polyester polyol (GP-3000, manufactured by KOREA POLYOL Co., Ltd.) containing 54 mgKOH/g of hydroxy and to an AN copolymer polyol (KE-848, containing 20% polyol of AN, manufactured by KOREA POLYOL Co., Ltd) containing 30 mgKOH/g of hydroxy, according to a mixing ratio as described in Table 1, to form a premix polyol. TDI as a polyisocyanate was added to the premix polyol, and the premix polyol including the TDI was agitated at 2000 rpm to form a semi-conductive slab foam at room temperature.

TABLE 1

| Material | Quantity (phr) |
|---|---|
| GP-3000 | 80 |
| KE-848 | 20 |
| TDI | 105 |
| stannous octoate (catalyst) | 0.3 |
| triethylamine (catalyst) | 0.2 |
| silicon (surfactant) | 1.5 |
| water (blowing agent) | 4.0 |
| ammonium salt (ionic | 10 |
| conductive substance) | |

The slab foam was impregnated with a resin solution having mixing ratio as described in Table 2.

TABLE 2

| Composition | Quantity (phr) |
|---|---|
| Water | 100 |
| Ketjen black 600J | 10 |
| Acrylic resin | 15 |

The impregnated slab foam was put in a roller, processed by squeezing, and dried by a forced air convection oven at approximately 130° C. for about 10 minutes. Then, the water solvent was removed to form the hybrid polyurethane foam of Example 1.

Properties of the hybrid polyurethane foam of Example 1 are as follows: a density is 70±10 kgf/m3, a hardness (ASKER F Type) is 50, a number of cells per inch (ppi) is 70±10 ppi, and a percentage of open cells is 50%.

In Example 1, a hybrid polyurethane foam toner supply roller was manufactured as follows. The hybrid polyurethane foam was cut by a vertical cutter into cubes of 25×25×250 mm. A hole having a diameter of 5.0 mm was formed into a center in a length direction of each of the cubes. A metal shaft having a diameter of 6.0 mm, wound with a hot melt sheet, was pressingly inserted into the hole. The foam and the shaft were attached to each other through the forced air convection oven at approximately 120° C. for about 30 minutes. The adhered hybrid polyurethane foam was polished by a polisher. Both ends of the foam were then cut. As a result, the hybrid polyurethane foam toner supply roller of Example 1, having outer diameter of 13.7 mm and length of 220 mm, was manufactured.

### EXAMPLE 2

A hybrid polyurethane foam toner supply roller of Example 2 was manufactured in the same method as Example 1, except that the polyurethane foam prepared as described with respect to Example 1 was post-processed before the polyurethane foam was impregnated with the same resin solution to form the hybrid polyurethane foam of Example 2. The post-processing was performed by putting the slab foam prepared as described with respect to Example 1 in a chamber and exploding closed cells of the slab foam by injecting nitrogen and hydrogen. The polyurethane foam of Example 2, prepared through such post-processing, has the same properties as that of Example 1, except that the percentage of the open cells is 80%.

### COMPARATIVE EXAMPLE

For comparison with the hybrid polyurethane foam toner supply rollers of Examples 1 and 2, a polyurethane foam toner supply roller was manufactured in the same method described with respect to Example 1, except that a nonconductive polyurethane foam was impregnated with the resin solution without adding the ionic conductive substance. Properties of the nonconductive polyurethane foam of the Comparative Example are the same as in Example 1.

Evaluation of the Toner Supply Rollers

Resistances and image qualities were evaluated with respect to the above polyurethane foam toner supply rollers per lot.

Resistance is measured as follows. The polyurethane foam toner supply roller to be measured is mounted to a jig, conductive shafts of 200 g are put on each end of the roller, 100 V of direct voltage (DC) is applied to the roller shaft, and the roller is rotated at a certain speed (for example, 30 rpm) to measure an electric current. The measured current is converted to a resistance per lot, described in Table 3.

TABLE 3

| | Lot 1 | Lot 2 | Lot 3 | Lot 4 | Lot 5 | Lot 6 |
|---|---|---|---|---|---|---|
| Comparative | 3.0E+04 | 9.0E+04 | 3.0E+05 | 8.0E+03 | 3.0E+07 | 6.0E+04 |
| Embodiment 1 | 2.0E+04 | 1.0E+04 | 5.0E+04 | 1.0E+04 | 3.0E+04 | 5.0E+04 |
| Embodiment 2 | 4.0E+04 | 1.0E+04 | 2.0E+04 | 4.0E+04 | 5.0E+04 | 2.0E+04 |

As can be appreciated from Table 3, the resistances per lot and resistance deviations are very low in the hybrid toner supply rollers of Examples 1 and 2 as compared to the toner supply roller of the Comparative Example.

On the other hand, so as to estimate a toner supply property with respect to the respective toner supply rollers, image qualities according to a number of printed sheets in a laser printer mounting the above toner supply rollers were evaluated, as described in Table 4, according to the following criteria: ∘=good, □=fair, and x=poor.

TABLE 4

| | Initial | 5,000 | 8,000 | 10,000 | 12,000 |
|---|---|---|---|---|---|
| classification | state | sheets | sheets | sheets | sheets |
| Comparative | ∘ | ∘ | ∘ | □ | x |
| Embodiment 1 | ∘ | ∘ | ∘ | ∘ | □ |
| Embodiment 2 | ∘ | ∘ | ∘ | ∘ | ∘ |

As can be appreciated from Table 4, the hybrid toner supply rollers of Examples 1 and 2, a supply of a solid image is superior to the Comparative Example, even with the low resistance deviation (see Table 3). In particular, regarding Example 2, when using the post-processed hybrid toner supply roller, the supply of the solid image can be considerably enhanced by preventing an inferior supply of toner to form the solid image.

As described above, according to the present general inventive concept, a hybrid toner supply roller that includes both an ionic conductive substance and an electroconductive substance is capable of realizing a low resistance. Furthermore, since the hybrid toner supply roller has low hardness and toner stress, the hybrid toner supply roller is suitable for use in an image forming apparatus requiring a high-speed operation and a long lifespan. In particular, in the hybrid toner supply roller, a resistance deviation per lot can be reduced. Moreover, the hybrid toner supply roller is price-competitive as compared to a conventional toner supply roller because the urethane foam is less expensive than silicon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A toner supply roller of a developing device, comprising:
a shaft; and
a conductive resilient member enclosing at least a portion of an outer circumference of the shaft and including a hybrid polyurethane foam in which an electron conductive substance is dispersed in a semi-conductive foam containing an ionic conductive substance.

2. The toner supply roller of claim 1, wherein the ionic conductive substance is at least one compound selected from the group consisting of ammonium salt, perchlorate, chlorate, hydrochlorate, bromate, oxoacidic salt, fluoroboric acid salt, sulphate, ethylsulphate, carboxylate, sulphonate, at least one of the above salts containing alkali metals, and at least one of the above salts containing alkaline earth metals.

3. The toner supply roller of claim 1, wherein the electron conductive substance comprises a conductive carbon black.

4. The toner supply roller of claim 1, wherein a percentage of open cells in the hybrid polyurethane foam is greater than or equal to 80%.

5. The toner supply roller of claim 1, wherein the hybrid polyurethane foam has a resistance of approximately 1.0E+03 to approximately 9.0E+05 when −100V DC is applied to the shaft and the shaft is rotated at 30 rotations per minute (rpm).

6. A method of manufacturing a toner supply roller of a developing device, the method comprising:
preparing a polyurethane foam;
fabricating a hybrid polyurethane foam by impregnating the polyurethane foam with a resin solution containing an electron conductive substance;
preparing a conductive resilient member by drying and cutting the hybrid polyurethane foam; and
inserting and attaching a shaft into the conductive resilient member.

7. The method of claim 6, wherein the preparing of the polyurethane foam comprises:
forming a premix polyol by adding a blowing agent, a surfactant, a catalyst, and a ionic conductive substance to a polyol; and
adding polyisocyanate to the premix polyol to obtain a semi-conductive slab foam.

8. The method of claim 7, wherein the blowing agent comprises water or a halide alkane compound.

9. The method of claim 7, wherein the catalyst is selected from the group consisting of organic metal compounds, amine compounds, and a mixture of those compounds.

10. The method of claim 7, wherein the ionic conductive substance is at least one compound selected from the group consisting of ammonium salt, perchlorate, chlorate, hydrochlorate, bromate, oxoacidic salt, fluoroboric acid salt, sulphate, ethylsulphate, carboxylate, sulphonate, at least one of the above salts containing alkali metals, and at least one of the above salts containing alkaline earth metals.

11. The method of claim 7, wherein the surfactant is added in an amount in a range of approximately 0.1 to approximately 5 phr based on a weight of the polyurethane foam.

12. The method of claim 7, further comprising:
post-processing the slab foam to obtain a filter foam.

13. The method of claim 12, wherein the filter foam is post-processed to include a percentage of open cells of at least 80%.

14. The method of claim 6, wherein the resin solution containing the electron conductive substance further includes a binder resin and a solvent.

15. The method of claim 14, wherein the electron conductive substance comprises conductive carbon black.

16. The method of claim 15, wherein the electron conductive substance is added in an amount in a range of approximately 3 to approximately 30 phr based on an amount of the resin solution.

17. The method of claim 14, wherein the binder resin comprises at least one substance selected from the group consisting of acrylic resin, polyacrylic acid ester resin, acrylic acid-styrene copolymer, polyvinyl alcohol, polyacrylamide, polyvinylchloride resin, urethane resin, vinyl acetate resin, butadiene resin, epoxy resin, alkyd resin, melamine resin, and chloroprene resin.

18. The method of claim 11, wherein the binder resin is added in an amount in a range of approximately 5 to approximately 30 phr based on an amount of the resin solution.

19. The method of claim 6, wherein the hybrid polyurethane foam is dried by hot air drying.

20. The method of claim 9, wherein the organic metal compounds comprise at least one metal selected from the group consisting of tin, lead, iron, and titanium.

21. A method of manufacturing a toner supply roller of a developing device useable in an image forming apparatus, the method comprising:
providing a conductive resilient member having a hybrid polyurethane foam including an electroconductive substance dispersed in a semi-conductive foam containing an ionic conductive substance; and
enclosing an outer circumference of a shaft with the conductive resilient member.

22. A toner supply unit to supply toner to a developing unit of an image forming apparatus, comprising:
a hybrid polyurethane foam, comprising:
at least one polyol;
at least one polyisocyanate;
at least one ionic conductive salt; and
at least one electroconductive substance.

23. A toner supply unit to supply toner to a developing unit of an image forming apparatus, comprising:
a hybrid polyurethane foam, comprising:
a semi-conductive polyurethane foam containing an ionic conductive salt and blown cells; and
an electroconductive substance dispersed in the cells of the semi-conductive polyurethane foam.

24. A toner supply unit to supply toner to a developing unit of an image forming apparatus, comprising:
a hybrid polyurethane foam, comprising:
a semi-conductive slab foam comprising at least one polyol, at least one polyisocyanate, and at least one ionic conductive salt; and
at least one electroconductive substance impregnated in the semi-conductive slab foam.

25. A method of manufacturing a hybrid polyurethane foam useable in a toner supply roller to supply toner to a developing unit of an image forming apparatus, the method comprising:
mixing at least one polyol, at least one catalyst, and at least one ionic conductive substance to form a premix polyol;
adding at least one polyisocyanate to the premix polyol to form a semi-conductive slab foam; and
impregnating the semi-conductive slab foam with at least one electroconductive substance.

26. The method of claim 25, further comprising:
inserting a shaft through the impregnated slab foam and attaching the shaft and the impregnated slab foam to each other.

27. The method of claim 26, further comprising:
exploding closed cells of the semi-conductive slab foam before impregnating the semi-conductive slab foam.
